(19) United States
(12) Patent Application Publication
(10) Pub. No.: US 2019/0138656 A1
(43) Pub. Date: May 9, 2019

(54) SYSTEMS AND METHODS FOR PROVIDING RECOMMENDED MEDIA CONTENT POSTS IN A SOCIAL NETWORKING SYSTEM

(71) Applicant: Facebook, Inc., Menlo Park, CA (US)

(72) Inventors: Wenyun Yang, Fremont, CA (US); Hsiao-Ping Tseng, Fremont, CA (US)

(21) Appl. No.: 15/805,922

(22) Filed: Nov. 7, 2017

(51) Int. Cl. G06F 17/30; G06N 99/00; G06N 7/00

(52) U.S. Cl. CPC G06F 17/30867; G06F 17/30554; G06N 7/005; G06N 99/005; G06F 17/3053

(57) ABSTRACT

Systems, methods, and non-transitory computer readable media can detect whether one or more media content items have been captured by a user. One or more candidate media content items to include in a suggested post for the user can be determined based on one or more of: specified criteria or a machine learning model. The suggested post for the user including the one or more candidate media content items can be generated. The suggested post can be provided for display in a user interface.

### FIELD OF THE INVENTION

The present technology relates to the field of social networks. More particularly, the present technology relates to techniques for providing content associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

A social networking system may provide resources through which users may publish content items. In one example, a content item can be presented on a profile page of a user. As another example, a content item can be presented through a feed for a user to access.

### SUMMARY

Various embodiments of the present disclosure can include systems, methods, and non-transitory computer readable media configured to detect whether one or more media content items have been captured by a user. One or more candidate media content items to include in a suggested post for the user can be determined based on one or more of: specified criteria or a machine learning model. The suggested post for the user including the one or more candidate media content items can be generated. The suggested post can be provided for display in a user interface.

In some embodiments, content of the one or more media content items is analyzed, and the determining the one or more candidate media content items is based on the analyzing the content of the one or more media content items.

In certain embodiments, the analyzing the content of the one or more media content items includes determining representations of the one or more media content items based on a machine learning model.

In an embodiment, the machine learning model is trained to predict a probability of a user publishing a media content item in a post.

In some embodiments, the machine learning model is trained based on training data including representations of media content items and labels indicating whether the media content items have been published.

In certain embodiments, the machine learning model is trained based on features relating to one or more of: user attributes, media content item attributes, or post attributes.

In an embodiment, the suggested post is published through a social networking system in response to user instruction.

In some embodiments, the suggested post includes one or more of: a description associated with a candidate photo, a social context, a user interface (UI) element for editing the suggested post, or a UI element for publishing the suggested post.

In certain embodiments, the specified criteria relates to one or more of: a distance between a location associated with a media content item and a location associated with the user, or a number of faces depicted in a media content item.

In an embodiment, the providing the suggested post for display includes ranking the suggested post and one or more content items to be provided in the user interface.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example post recommendation module configured to provide recommended posts including media content items, according to an embodiment of the present disclosure.

FIG. 2A illustrates an example photo selection module configured to select media content items for inclusion in a suggested post, according to an embodiment of the present disclosure.

FIG. 2B illustrates an example suggested post module configured to provide a suggested post including media content items, according to an embodiment of the present disclosure.

FIG. 3A illustrates an example user interface for providing recommended posts including media content items, according to an embodiment of the present disclosure.

FIG. 3B illustrates an example user interface for providing recommended posts including media content items, according to an embodiment of the present disclosure.

FIG. 3C illustrates a functional block diagram for providing recommended posts including media content items, according to an embodiment of the present disclosure.

FIG. 4 illustrates an example first method for providing recommended posts including media content items, according to an embodiment of the present disclosure.

FIG. 5 illustrates an example second method for providing recommended posts including media content items, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Recommended Media Content Posts in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed for a user to access.

Conventional approaches specifically arising in the realm of computer technology can allow users to create and publish posts. For example, a post can include text and/or one or more media content items, such as photos. In order to publish a post including a photo, a user can create a post, add text for the post, add one or more photos for the post, and publish the post. Accordingly, under conventional approaches, users may have to take multiple steps in order to publish posts including media content items, which can be inefficient and can deter users from publishing posts including media content items.

An improved approach rooted in computer technology can overcome the foregoing and other disadvantages associated with conventional approaches specifically arising in the realm of computer technology. Based on computer technology, the disclosed technology can generate and provide recommended or suggested posts including media content items to users. For example, the disclosed technology can detect that one or more media content items, such as photos (or videos), have been captured on a computing device of a user and generate a suggested post including one or more captured media content items. One or more captured media content items can be selected for inclusion in a suggested post based on analysis of the captured media content items. In some embodiments, captured media content items can be analyzed based on machine learning techniques. For example, a machine learning model can be trained to recognize objects and/or attributes associated with media content items. A media content item can be represented as a set of features, or a feature vector, based on the analysis. A captured media content item can be selected for inclusion in a suggested post based on specified criteria and/or a probability of the captured media content item being published in a post by a user. In some embodiments, the probability of a decision by a user to publish the captured media content item in a post can be determined based on machine learning techniques. For example, a machine learning model can be trained to predict the probability of the captured media content item being published based on training examples. A suggested post can be provided on various surfaces, such as a feed of a user. The user can proceed to publish the suggested post, for example, by selecting a user interface element, such as a button. The user may edit the suggested post prior to publishing the suggested post. In this manner, the disclosed technology can provide an efficient way of publishing posts including media content items. Additional details relating to the disclosed technology are provided below.

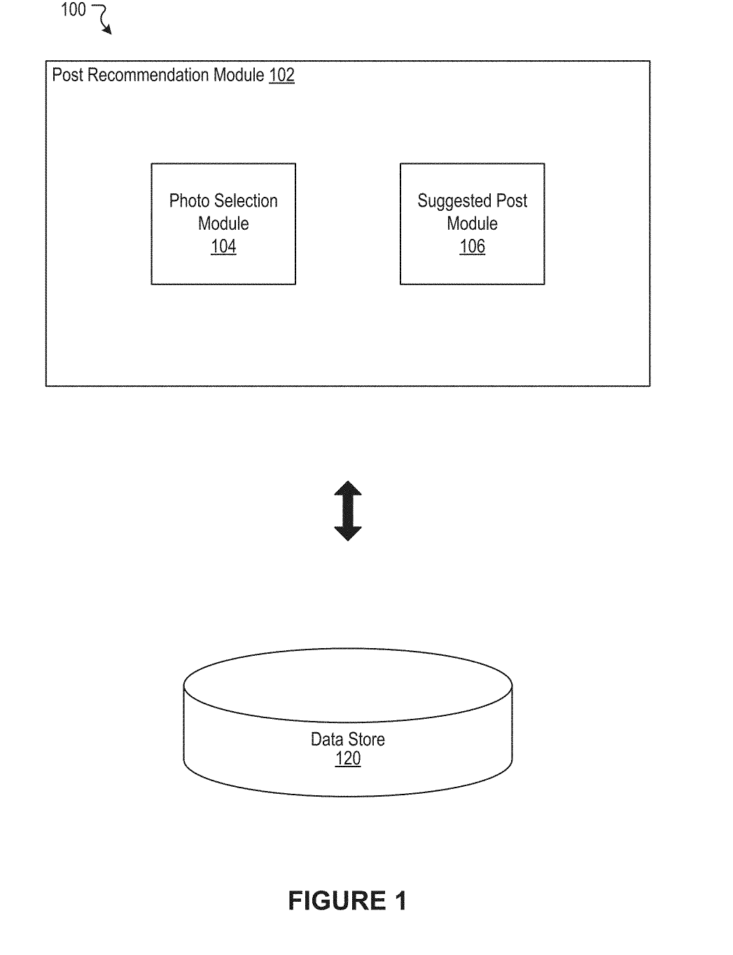

FIG. 1 illustrates an example system 100 including an example post recommendation module 102 configured to provide recommended posts including media content items, according to an embodiment of the present disclosure. The post recommendation module 102 can include a photo selection module 104 and a suggested post module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the post recommendation module 102 can be implemented in any suitable combinations. While the disclosed technology is described in connection with posts and media content items associated with a social networking system for illustrative purposes, the disclosed technology can apply to any other type of system and/or content. In some embodiments, the disclosed technology can also apply to other types of entities or objects, distinct from posts, that are represented in a social networking system.

The photo selection module 104 can select media content items for inclusion in a suggested post. For example, whether media content items have been captured on a computing device of a user can be detected, and content of captured media content items can be analyzed to determine one or more candidate media content items to include in a suggested post. Functionality of the photo selection module 104 is described in more detail herein.

The suggested post module 106 can provide a suggested post including candidate media content items. For example, a suggested post can be generated based on one or more candidate media content items selected by the photo selection module 104. A suggested post can be published through a social networking system if a user chooses to publish the suggested post. Functionality of the suggested post module 106 is described in more detail herein.

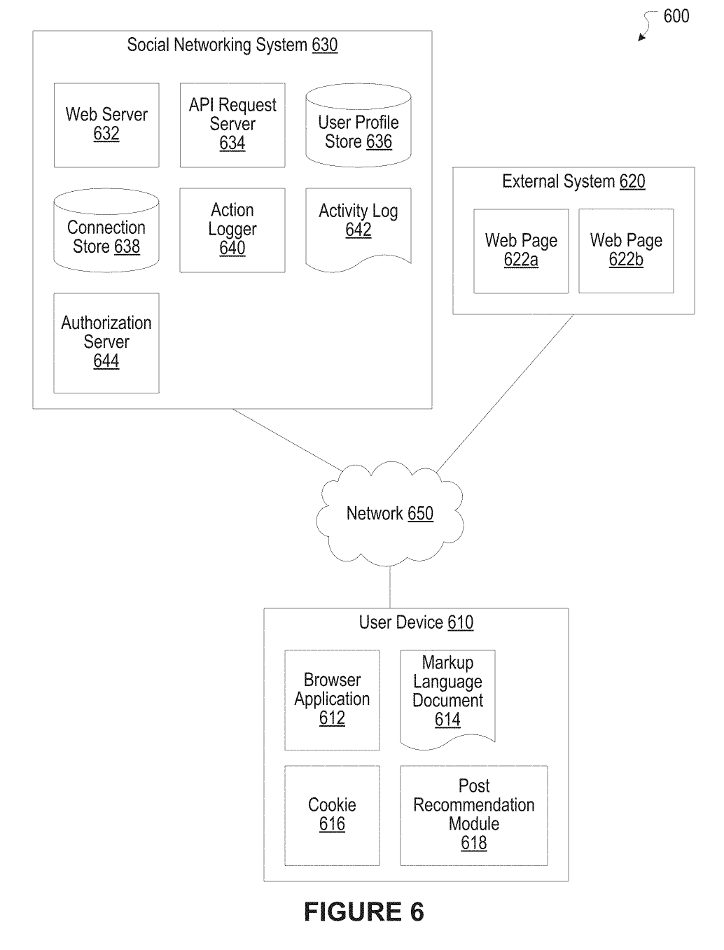

In some embodiments, the post recommendation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the post recommendation module 102 can be, in part or in whole, implemented as software running on one or more computing devices or systems, such as on a server system or a client computing device. In some instances, the post recommendation module 102 can be, in part or in whole, implemented within or configured to operate in conjunction or be integrated with a social networking system (or service), such as a social networking system 630 of FIG. 6. Likewise, in some instances, the post recommendation module 102 can be, in part or in whole, implemented within or configured to operate in conjunction or be integrated with a client computing device, such as the user device 610 of FIG. 6. For example, the post recommendation module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the post recommendation module 102. The data maintained by the data store 120 can include, for example, information relating to posts, media content items (e.g., photos, videos, etc.), object detection or recognition models or algorithms, attributes associated with media content items, recommended or suggested posts, criteria for providing recommended or suggested posts, machine learning models, ranking, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the post recommendation module 102 can be configured to communicate and/or operate with the data store 120. In some embodiments, the data store 120 can be a data store within a client computing device. In some embodiments, the data store 120 can be a data store of a server system in communication with the client computing device.

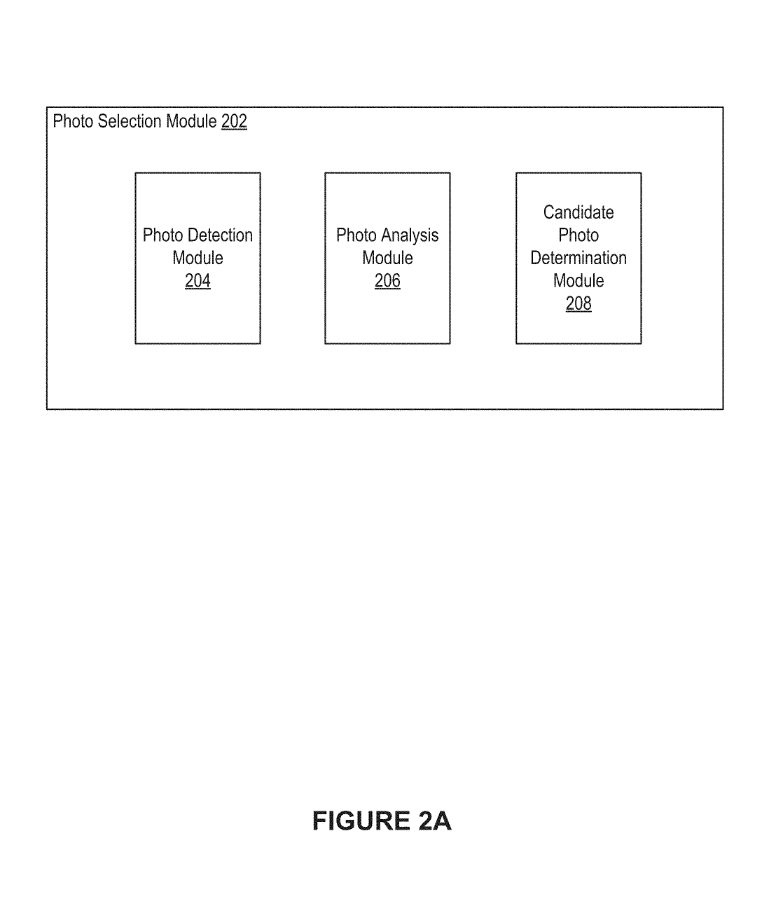

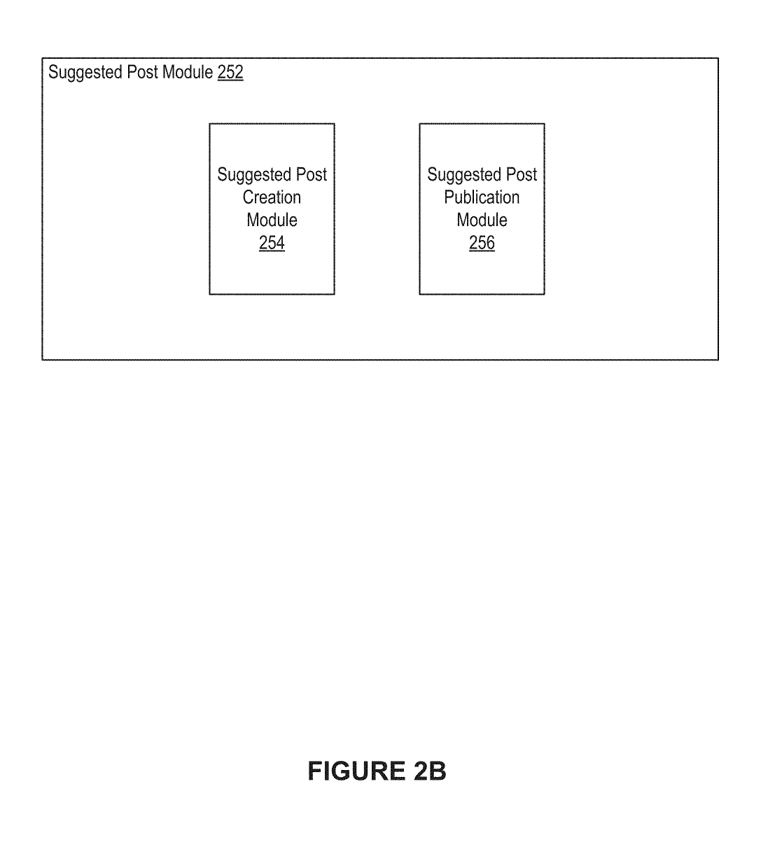

FIG. 2A illustrates an example photo selection module 202 configured to select media content items for inclusion in a suggested post, according to an embodiment of the present disclosure. In some embodiments, the photo selection module 104 of FIG. 1 can be implemented with the example photo selection module 202. As shown in the example of FIG. 2A, the example photo selection module 202 can include a photo detection module 204, a photo analysis module 206, and a candidate photo determination module 208.

The photo selection module 202 can select one or more media content items to include in a suggested post provided to a user. A suggested post can indicate a post that is provided to a user for possible publication. A post can include any type of content that can be published on a social networking system. In some embodiments, a post can also be referred to as a “story.” The photo selection module 202 can select the one or more media content items based on specified criteria, machine learning techniques, or both. Media content items can include any type of media content, such as images, videos, text, audio, etc. For example, media content items can include photos captured through a camera on a computing device of a user. The disclosed technology is described in connection with photos below for illustrative purposes, but the disclosed technology can apply to any type of media content items.

The photo detection module 204 can detect whether photos have been captured on a computing device of a user. For example, a user may capture a photo using a camera associated with a computing device (e.g., a front facing camera, a rear facing camera, etc.), and the photo detection module 204 can detect that the photo has been captured. In some embodiments, the photo detection module 204 can detect photos on the computing device that have not been captured on the computing device, such as photos that the user saved or downloaded to the computing device. In certain embodiments, the photo detection module 204 can periodically check for new photos that have been captured since a particular time. For example, the photo detection module 204 can communicate with an operating system resource or camera storage module of a computing device to determine the existence of photos captured by the computing device. Many variations are possible. In some embodiments, the photo detection module 204 can send a notification to a server associated with the social networking system upon or after detecting new photos. In these embodiments, the server may create a placeholder for inserting a suggested post on a page in response to the notification, as described below in connection with FIG. 2B.

The photo analysis module 206 can analyze content of photos. For example, the photo analysis module 206 can perform object detection or facial detection to analyze subject matter depicted in photos and determine attributes associated with photos. A photo can be represented as a set of features (e.g., a feature vector). Each feature included in a representation of a photo can be associated with an attribute, such as a visual attribute or a nonvisual attribute. Examples of visual attributes can include whether a photo depicts a particular object, a particular concept, a particular theme, a particular animal, a particular person or people in general, etc. Examples of visual attributes can also include whether a photo is a selfie, is a group photo, depicts a landscape, etc. Examples of nonvisual attributes may include metadata for photos or other information associated with photos. A value for a feature can indicate a likelihood of a photo being associated with a corresponding attribute. In certain embodiments, a feature can indicate whether a photo is associated with a particular category. For example, a category can relate to an object, a concept, a theme, an animal, one or more people, etc. In some embodiments, representations of photos can be determined based on machine learning techniques, such as machine vision or computer vision techniques. For example, a machine learning model can be trained to determine representations of photos based on training data. The training data can include, for example, pixel data for photos and labels corresponding to various attributes associated with the photos. In certain embodiments, the machine learning model can include a neural network, such as a deep neural network (DNN), a convolutional neural network (CNN), etc.

In some embodiments, the photo analysis module 206 can also perform facial recognition of people included in photos. For example, faces in photos can be recognized based on machine learning techniques. The photo analysis module 206 can determine relationships between a user and one or more recognized faces of others. For instance, a recognized face can be associated with another user, and the user and the other user can be connections within the social networking system. A coefficient or weight associated with the connection between the user and the other user can be indicative of a strength of the connection. The coefficient associated with the connection between the user and the other user can be considered in selecting one or more candidate photos for inclusion in a suggested post, as described below. A connection between two users within the social networking system can be unilateral (e.g., one-way) or bilateral (e.g., two-way).

The candidate photo determination module 208 can select one or more candidate photos to include in a suggested post based on specified criteria or a probability of a user publishing a photo in a post, or both. The specified criteria can relate to determining which photos a user is more likely to publish or share in a post. In some embodiments, the specified criteria can include a distance of a location associated with or reflected in a photo from a location typically associated with a user, a number of faces or people in a photo, etc. For instance, a user can be more likely to share photos that are taken on a trip, which may be indicated by a location that is not close to the user's typical location, such as a city of residence. Also, a user can be more likely to share photos including more than one face or person (e.g., a group photo) compared to photos including only one face or person (e.g., a selfie). As an example, the specified criteria can indicate photos that are taken at a location that is a threshold distance away from a user's typical location and/or photos that are group photos should be included in a suggested post. Many variations are possible. The candidate photo determination module 208 can select one or more photos that satisfy the specified criteria as a candidate photo(s).

The candidate photo determination module 208 can also train a machine learning model to predict a probability of a decision by a user to publish a photo in a post. For example, a machine learning model can be trained based on training data including representations of photos and labels indicating whether photos have been published in posts. The training data for training the machine learning model can include various features. For example, the training data can include features relating to user attributes and photo attributes. User attributes can include any attributes associated with users. Examples of user attributes can include a user's activities or history on a social networking system, such as a number of photos a user has published, a number of photos a user has published in a specific time period (e.g., last day, last month, etc.), an average publish rate for photos, a user's likes on photos of the user's connections, a user's comments on photos of the user's connections, etc. A time period can be specified in an appropriate unit of time (e.g., an hour(s), a day(s), a month(s), etc.). Examples of user attributes can also include information associated with a profile of a user, a location of a user (e.g., a country, state, county, city, etc.), an age, an age range, a gender, a language, etc. Photo attributes can include any attributes associated with photos. As explained above, each feature in the set of features included in a representation of a photo can relate to an attribute associated with the photo. The training data can include some or all of features in the set of features included in representations of photos. Examples of photo attributes can include whether a photo is a selfie, whether a photo is a group photo, whether a photo depicts a landscape, a location associated with a photo, whether a photo is taken at a location that is a threshold distance from a typical location associated with a user, a coefficient associated with a connection between a user and another user depicted in a photo, etc. In some embodiments, the training data can also include features relating to post attributes. Post attributes can include any attributes associated with posts. In certain embodiments, the training data for training the machine learning model can also include photos that were included in suggested posts previously shown to users and labels indicating whether the photos were published. Weights associated with various features used to train the machine learning model can be determined. In some embodiments, the candidate photo determination module 208 can train a personalized machine learning model for each user based on training data including data specific to the particular user. The training data for each user can include information and features as described above. The candidate photo determination module 208 can retrain the machine learning model based on new or updated training data.

The candidate photo determination module 208 can apply the trained machine learning model to predict a probability of a user publishing a photo in a post. For example, a representation of a photo can be provided to the trained machine learning model, and the trained machine learning model can output a probability of a user publishing the photo in a post. In some embodiments, the candidate photo determination module 208 can output a score indicative of a probability of a user publishing the photo in a post. Photos can be ranked based on respective scores. In some embodiments, the candidate photo determination module 208 can select one or more top ranked photo as a candidate photo(s) to include in a suggested post. In other embodiments, the candidate photo determination module 208 can select one or more photos having scores that satisfy a threshold value as a candidate photo(s) to include in a suggested post. One or more machine learning models discussed in connection with the post recommendation module 102 and its components can be implemented separately or in combination, for example, as a single machine learning model, as multiple machine learning models, as one or more staged machine learning models, as one or more combined machine learning models, etc. The one or more machine learning models can be trained on a computing device of a user or on a server associated with a social networking system in communication with the computing device of the user, or both.

In some embodiments, the candidate photo determination module 208 may not select any candidate photos. As an example, photos may not satisfy specified criteria. As another example, scores of photos indicative of probabilities of a user publishing the photos in posts may not satisfy a threshold value. In such cases, a suggested post is not created. In certain embodiments, the candidate photo determination module 208 may filter certain photos based on attributes associated with photos. For example, photos that include content that is not desired or appropriate may be filtered and may not be selected as candidate photos. All examples herein are provided for illustrative purposes, and there can be many variations and other possibilities.

FIG. 2B illustrates an example suggested post module 252 configured to provide a suggested post including media content items, according to an embodiment of the present disclosure. In some embodiments, the suggested post module 104 of FIG. 1 can be implemented with the example suggested post module 252. As shown in the example of FIG. 2B, the example suggested post module 252 can include a suggested post creation module 254 and a suggested post publication module 256.

The suggested post creation module 254 can generate a suggested post including one or more candidate photos, for example, as selected by the photo selection module 202 as described above. A suggested post can include default text, such as a description relating to a candidate photo. In some embodiments, the suggested post creation module 254 can automatically generate a description based on analysis of content of a candidate photo, for example, as described in connection with the photo analysis module 206, as described above. As an example, the description can include a time or time period associated with a candidate photo, a location associated with a candidate photo, names of objects and/or people depicted in a candidate photo, words or phrases relating to background, etc. In certain embodiments, a suggested post can include information relating to social context associated with the suggested post. Social context can indicate activities of a user or connections of a user within a social networking system. For instance, the social context associated with the suggested post can indicate the user's connections who have decided to publish suggested posts provided by the social networking system. As an example, the social context can indicate which of the user's connections have published and/or a number of the user's connections who have published suggested posts.

In some embodiments, a suggested post can be generated and rendered on the client side (e.g., on a computing device of a user) without communicating with a server associated with the social networking system. For instance, after new photos are detected on a computing device of a user, for example, by the photo detection module 204 as described above, the suggested post creation module 254 can generate and provide a suggested post for the user including one or more candidate photos on the computing device. In other embodiments, a notification can be sent to a server associated with the social networking system when new photos have been detected on a computing device, and the server can create a placeholder for a suggested post in data to be provided to the computing device. For example, the data can include various content items, such as a list of posts. The suggested post creation module 254 can generate and insert a suggested post into the placeholder after receiving the data, and the suggested post creation module 254 can render the data with the suggested post.

The suggested post creation module 254 can provide a suggested post on various surfaces, such as a feed of a user, a profile of a user, etc. In some embodiments, a suggested post may be provided at a particular location or position in a user interface. As an example, a suggested post may be provided at the top of the user interface. In other embodiments, a suggested post may be provided in a user interface in a ranked order, along with other content items. For example, a suggested post and other content items that are candidates for providing on a surface can be ranked based on ranking criteria, and the suggested post can be provided on the surface in an order or at a position that is based on the ranking. As an example, the suggested post can be provided in a feed of a user, and the suggested post and other content items can be provided in the feed based on an order of the ranking. In certain embodiments, a suggested post and other content items can be ranked based on a value model. The value model can indicate importance of an event or a type of content item associated with the social networking system. For instance, the value model can assign a value for an event or a type of content item. An event can have a probability and a value associated with it. As an example, a user publishing a photo in a post can be considered an event, and the value model can indicate a value associated with the event of a user publishing a photo in a post. In some embodiments, a score of a suggested post can be determined based on the probability of a user publishing a photo in the suggested post and the value associated with the event of publishing a photo in a post. In some embodiments, the value model can be based on likelihood of engagement by users in connection with events or types of content items. For example, the value model can assign a value associated with a user publishing a photo in a post that reflects a likelihood of engagement by a user.

In some embodiments, the suggested post creation module 254 can determine or limit a number of suggested posts to provide within a particular time period. For example, only one suggested post may be provided to a user within a specific time period in order to avoid providing too many suggested posts to the user. A time period can be specified in an appropriate unit of time (e.g., an hour(s), a day(s), a month(s), etc.).

The suggested post publication module 256 can publish a suggested post in response to user selection or confirmation. In some embodiments, publishing a suggested post can be performed in one step, such as one action taken by a user. For example, a user interface (UI) element for publishing the suggested post can be automatically provided by the suggested post publication module 256, and the suggested post can be published if the user selects the UI element. Examples of UI elements can include a button, a link, an icon, an image, etc. A user can select a UI element by a click, a touch gesture, etc. In other embodiments, publishing a suggested post can be performed in two steps. A user may edit a suggested post prior to choosing to publish the suggested post. For example, a UI element for editing the suggested post can be provided initially, and then, a UI element for publishing the suggested post can be provided. Many variations are possible.

In this way, the disclosed technology can facilitate creating and publishing posts including photos in an efficient manner. The disclosed technology can protect privacy of a user since a suggested post can be generated and rendered on a computing device of the user without sending photos to a server associated with the social networking system. In some embodiments, a user can opt in to functionalities associated with suggested posts. In other embodiments, functionalities associated with suggested posts can be provided as default, and a user can opt out of the functionalities. All examples herein are provided for illustrative purposes, and there can be many variations and other possibilities.

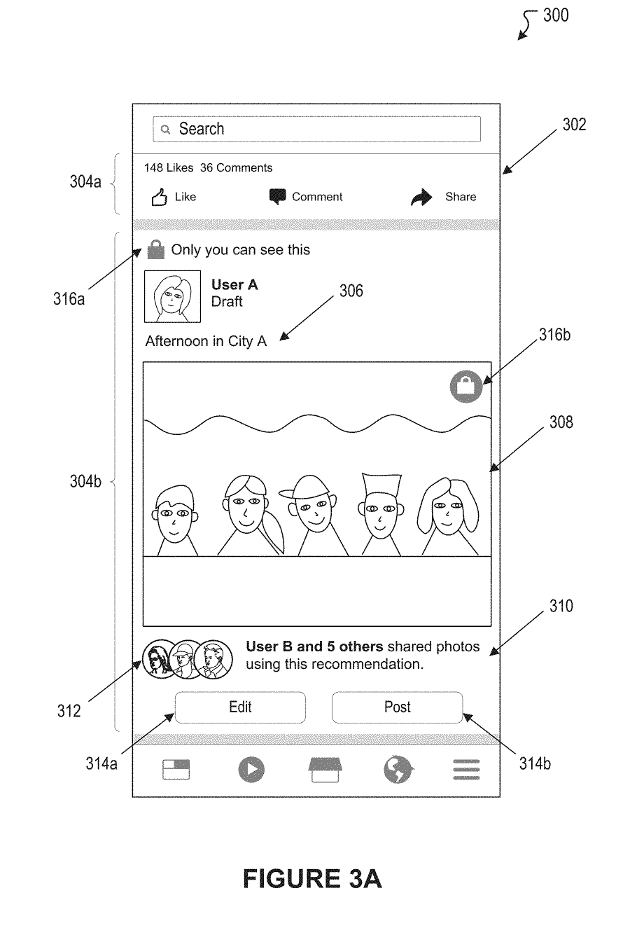

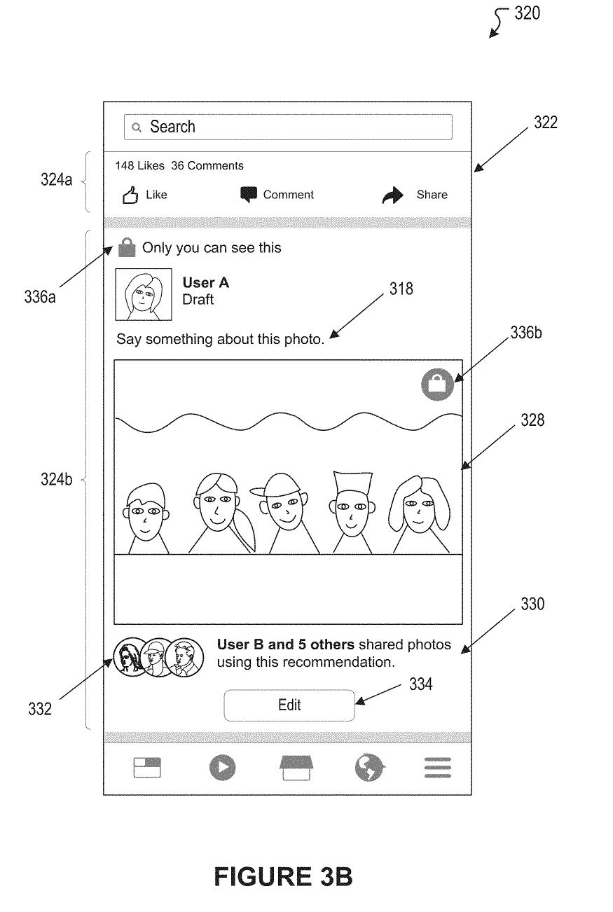

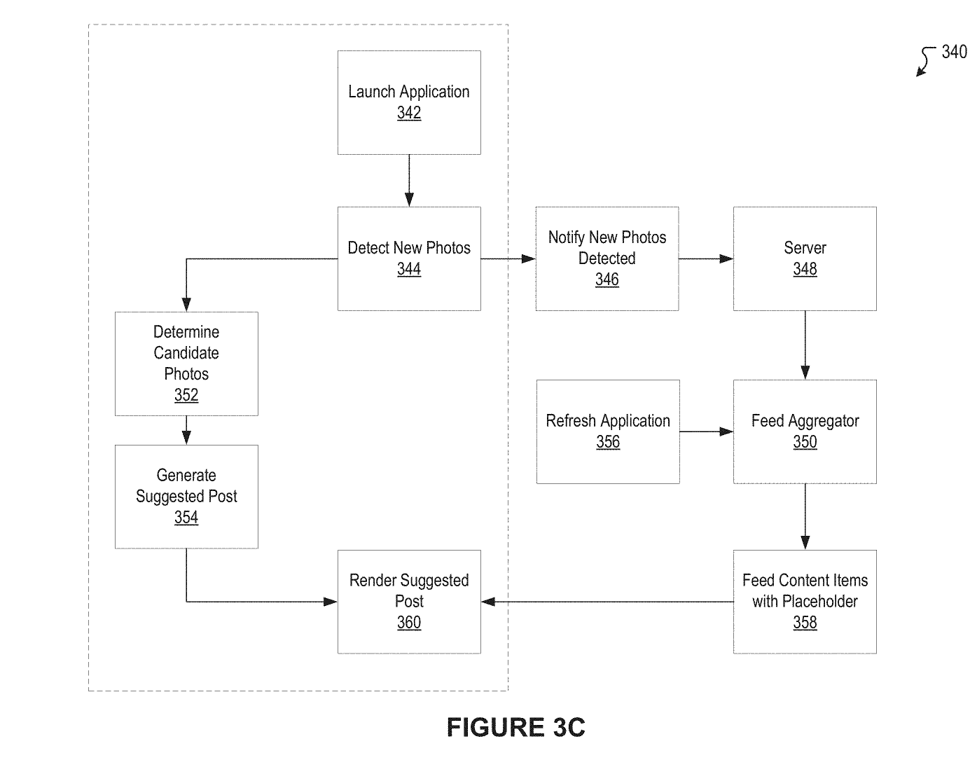

FIG. 3A illustrates an example user interface 300 for providing recommended posts including media content items, according to an embodiment of the present disclosure. The user interface 300 shows a feed 302 of a user that includes one or more posts 304a, 304b. The feed 302 can include a suggested post 304b. For example, the suggested post 304b can be generated by the post recommendation module 102, as discussed herein. The suggested post 304b can include a description 306, a candidate photo 308, social context 310, an edit button 314a for editing the suggested post 304b, and a post button 314b for publishing or posting the suggested post 304b. The description 306 can be automatically generated based on analysis of content or metadata of the candidate photo 308. In some embodiments, the description 306 can include a location and a time or time period associated with the candidate photo 308. In certain embodiments, the description 306 can include names of users who are included in the candidate photo 308. The social context 310 can include avatars or profile photos 312 of connections of the user who have published suggested posts. The suggested post 304b can also include one or more icons 316a, 316b that indicate that the suggested post 304b, including the candidate photo 308, is only visible to the user. In the example of FIG. 3A, if the user does not edit the suggested post 304b, the user can publish the suggested post 304b in one step, for example, by selecting the post button 314b. All examples herein are provided for illustrative purposes, and there can be many variations and other possibilities.

FIG. 3B illustrates an example user interface 320 for providing recommended posts including media content items, according to an embodiment of the present disclosure. In FIG. 3B, the user interface 320 shows another version of a suggested post. The user interface 320 shows a feed 322 of a user that includes one or more posts 324a, 324b. The feed 322 and posts 324a, 324b can be similar to the feed 302 and posts 304a, 304b in FIG. 3A. The feed 322 can include a suggested post 324b, which is similar to the suggested post 304b in FIG. 3A. The suggested post 324b can include a candidate photo 328, social context 330, and an edit button 334, which can be similar to the candidate photo 308, the social context 310, and the edit button 314a in FIG. 3A, respectively. The suggested post 324b can also include one or more icons 336a, 336b, which can be similar to the icons 316a, 316b in FIG. 3A. The suggested post 324b can also include a prompt 318 to add text or a description to the suggested post 324b. In the example of FIG. 3B, the user publishes the suggested post 324b in more than one step. For example, the user first edits the suggested post 324b by selecting the edit button 334. Edits made by the user can include, for example, addition of text or a description to the suggested post 324b, as indicated by the prompt 318. After the user edits the suggested post 324b, the user can proceed to publish the suggested post 324b. For example, a subsequent screen may show a button for publishing the suggested post 324b. All examples herein are provided for illustrative purposes, and there can be many variations and other possibilities.

FIG. 3C illustrates a functional block diagram 340 for providing recommended posts including media content items, according to an embodiment of the present disclosure. At block 342, a user can launch an application associated with a social networking system on a computing device of the user. At block 344, new photos on the computing device can be detected. If new photos are detected at block 344, at block 346, a notification that new photos are detected can be sent from the computing device to a server 348 associated with the social networking system. The server 348 can send the notification to a feed aggregator 350, which can obtain content items to provide to users from various sources, such as feeds. If new photos are detected at block 344, at block 352, candidate photos can be determined. At block 354, a suggested post can be generated. At block 356, the user can refresh the application, which can trigger the feed aggregator 350 to provide feed content items with a placeholder 358 to the computing device. For example, the feed aggregator 350 can include a placeholder for inserting a suggested post in a list of feed content items. At block 360, the suggested post can be rendered and inserted at the placeholder. In some embodiments, a suggested post can be generated and rendered on the computing device without involving a server associated with a social networking system. In these embodiments, a suggested post can be generated based on blocks indicated in dashed lines shown in FIG. 3C. For example, a suggested post can be generated without notifying a server associated with the social networking system and without receiving feed content items with a placeholder from the server and/or a feed aggregator. All examples herein are provided for illustrative purposes, and there can be many variations and other possibilities.

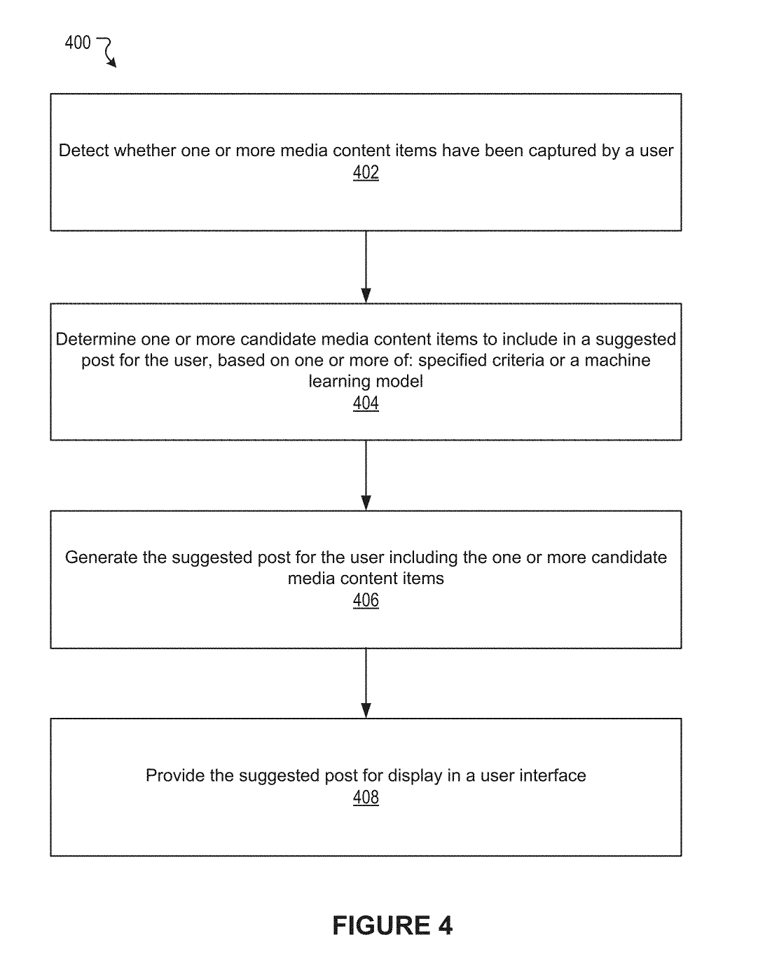

FIG. 4 illustrates an example first method 400 for providing recommended posts including media content items, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can detect whether one or more media content items have been captured by a user. At block 404, the example method 400 can determine one or more candidate media content items to include in a suggested post for the user, based on one or more of: specified criteria or a machine learning model. At block 406, the example method 400 can generate the suggested post for the user including the one or more candidate media content items. At block 408, the example method 400 can provide the suggested post for display in a user interface. Other suitable techniques that incorporate various features and embodiments of the present disclosure are possible.

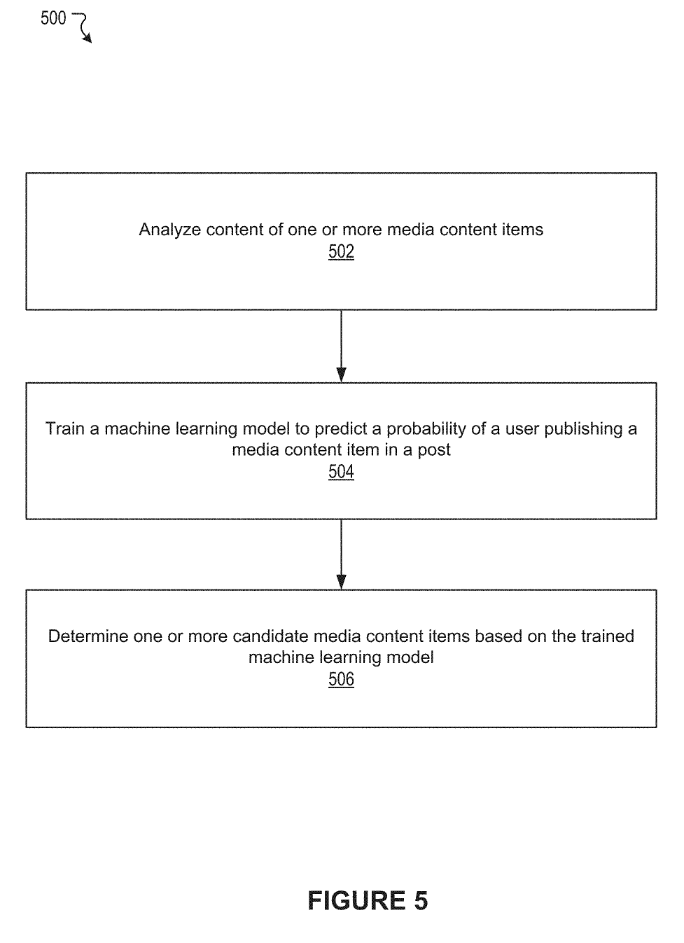

FIG. 5 illustrates an example second method 500 for providing recommended posts including media content items, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can analyze content of one or more media content items. At block 504, the example method 500 can train a machine learning model to predict a probability of a user publishing a media content item in a post. At block 506, the example method 500 can determine one or more candidate media content items based on the trained machine learning model. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the user device 610 can include a post recommendation module 618. The post recommendation module 618 can be implemented with the post recommendation module 102, as discussed in more detail herein. In some embodiments, one or more functionalities of the post recommendation module 618 can be implemented in the social networking system 630.

### Hardware Implementation

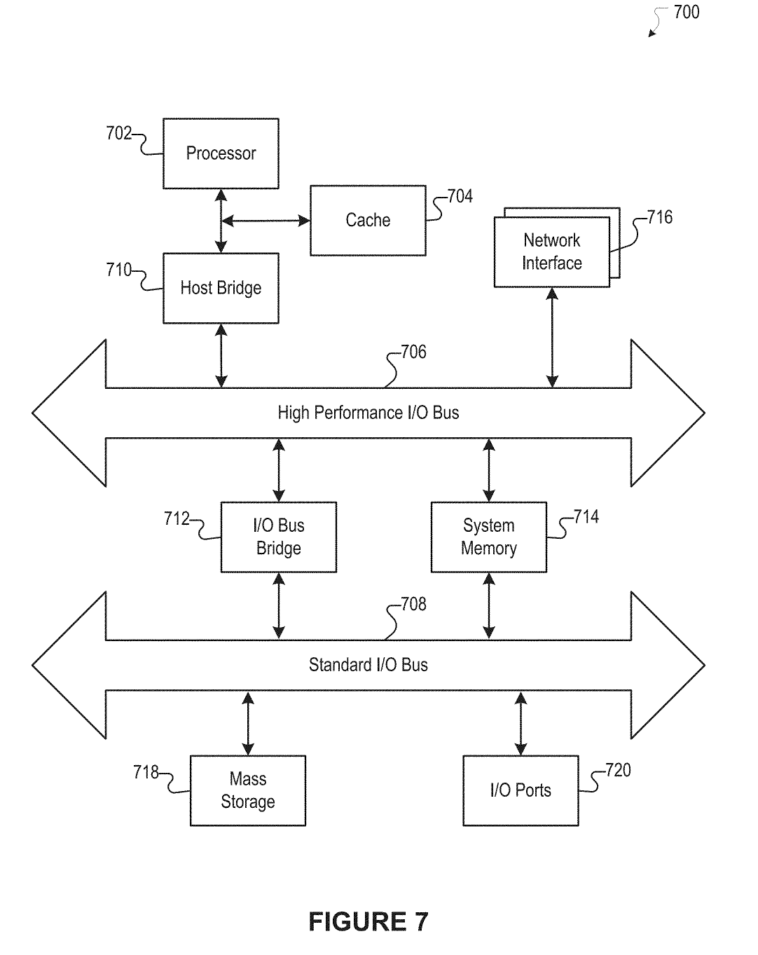

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, California, as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
detecting, by a computing system, whether one or more media content items have been captured by a user;
determining, by the computing system, one or more candidate media content items to include in a suggested post for the user, based on one or more of: specified criteria or a machine learning model;
generating, by the computing system, the suggested post for the user including the one or more candidate media content items; and
providing, by the computing system, the suggested post for display in a user interface.

2. The computer-implemented method of claim 1, further comprising analyzing content of the one or more media content items, and wherein the determining the one or more candidate media content items is based on the analyzing the content of the one or more media content items.

3. The computer-implemented method of claim 2, wherein the analyzing the content of the one or more media content items includes determining representations of the one or more media content items based on a machine learning model.

4. The computer-implemented method of claim 1, wherein the machine learning model is trained to predict a probability of a user publishing a media content item in a post.

5. The computer-implemented method of claim 4, wherein the machine learning model is trained based on training data including representations of media content items and labels indicating whether the media content items have been published.

6. The computer-implemented method of claim 4, wherein the machine learning model is trained based on features relating to one or more of: user attributes, media content item attributes, or post attributes.

7. The computer-implemented method of claim 1, further comprising publishing the suggested post through a social networking system in response to user instruction.

8. The computer-implemented method of claim 1, wherein the suggested post includes one or more of: a description associated with a candidate photo, a social context, a user interface (UI) element for editing the suggested post, or a UI element for publishing the suggested post.

9. The computer-implemented method of claim 1, wherein the specified criteria relates to one or more of: a distance between a location associated with a media content item and a location associated with the user, or a number of faces depicted in a media content item.

10. The computer-implemented method of claim 1, wherein the providing the suggested post for display includes ranking the suggested post and one or more content items to be provided in the user interface.

11. A system comprising:
at least one hardware processor; and
a memory storing instructions that, when executed by the at least one processor, cause the system to perform:
detecting whether one or more media content items have been captured by a user;
determining one or more candidate media content items to include in a suggested post for the user, based on one or more of: specified criteria or a machine learning model;
generating the suggested post for the user including the one or more candidate media content items; and
providing the suggested post for display in a user interface.

12. The system of claim 11, wherein the instructions further cause the system to perform analyzing content of the one or more media content items, and wherein the determining the one or more candidate media content items is based on the analyzing the content of the one or more media content items.

13. The system of claim 11, wherein the machine learning model is trained to predict a probability of a user publishing a media content item in a post.

14. The system of claim 13, wherein the machine learning model is trained based on training data including representations of media content items and labels indicating whether the media content items have been published.

15. The system of claim 11, wherein the specified criteria relates to one or more of: a distance between a location associated with a media content item and a location associated with the user, or a number of faces depicted in a media content item.

16. A non-transitory computer readable medium including instructions that, when executed by at least one hardware processor of a computing system, cause the computing system to perform a method comprising:
detecting whether one or more media content items have been captured by a user;
determining one or more candidate media content items to include in a suggested post for the user, based on one or more of: specified criteria or a machine learning model;
generating the suggested post for the user including the one or more candidate media content items; and
providing the suggested post for display in a user interface.

17. The non-transitory computer readable medium of claim 16, wherein the method further comprises analyzing content of the one or more media content items, and wherein the determining the one or more candidate media content items is based on the analyzing the content of the one or more media content items.

18. The non-transitory computer readable medium of claim 16, wherein the machine learning model is trained to predict a probability of a user publishing a media content item in a post.

19. The non-transitory computer readable medium of claim 18, wherein the machine learning model is trained based on training data including representations of media content items and labels indicating whether the media content items have been published.

20. The non-transitory computer readable medium of claim 16, wherein the specified criteria relates to one or more of: a distance between a location associated with a media content item and a location associated with the user, or a number of faces depicted in a media content item.
